(19) United States
(12) Patent Application Publication
(10) Pub. No.: US 2017/0310192 A1
(43) Pub. Date: Oct. 26, 2017

(54) Arrangement For Casing Of ODP Type Motors With Part Of The Casing Being Closed By The Connection Box

(71) Applicant: WEG Equipamentos Elétricos S.A. - Motores, Jaraguá do Sul (BR)

(72) Inventors: Cassiano Antunes Cezário, Jaraguá do Sul (BR); Jose Roberto Dos Santos, Jaraguá do Sul (BR)

(21) Appl. No.: 15/517,158

(22) PCT Filed: Oct. 9, 2014
(86) PCT No.: PCT/BR2014/000367

§ 371 Date: Apr. 5, 2017

(51) Int. Cl. H02K 5/22

(52) U.S. Cl. CPC H02K 5/225

(57) ABSTRACT

Engine housings feature an opening on the housing through which electric connection is enabled, as well as temporary maintenance. An ODP-type engine housing including a metal housing with a side opening, the opening compatible with the shape of the bottom of the junction box, enabling the junction box to partially close the opening of the housing. Consequently, when the junction box is attached, the housing is closed in order to facilitate the closing operation, as well as reducing manufacturing complexity, total mass of the housing and, consequently, manufacturing costs.

### FIELD OF APPLICATION

This model consist of an Open, Drip Proof (ODP)-type engine housing, comprising a metal housing with a side opening, said opening compatible with the shape of the bottom of the junction box, enabling said junction box to partially close the opening of the housing. Said opening allows for cost reduction in casting processes, by enabling cost reduction from the usage of casting plugs.

### BACKGROUND OF THE INVENTION

Engines with “Open Drip Proof” (ODP)-type housings feature a metal housing that is produced mainly through a casting process. The shape of the housing resembles a cylinder, block, or rectangle with one of the ends open and shielded by a deflector, which allows passage of cooling air. At the center of the deflector of the cover, there is a hole on which the engine shaft is placed.

In the construction of electric engines, housings have an opening in their structure that function as an access point to the inner chamber, enabling the connection of electric terminals of the engine winding, as well as allowing maintenance without the need to disassemble the entire engine. Although necessary, the opening (3) requires another part to be fixed to the housing in order to close said opening (3).

Therefore, this type of motor features simple assembly and a small amount of parts, preventing a great amount of construction variants or reduction of assembly costs.

In casting processes, critical operations are generally related to the molding of the piece and core molding of its components. The latter consists in obtaining plugs (normally made from refractory materials) and their addition to the molds, in order to form cavities, holes and indentations on the pieces.

Thus, in light of the foregoing, the demand for solutions that relinquish the core-making phase on the casting of large-scale engines is evident, as to enable viability on industrial scale.

### DESCRIPTION OF THE STATE OF THE ART

The state of the art features documents in which devices for placement, fixation and shaping of junction boxes to engines are presented.

In this regard, one proposal is disclosed by the utility model CN202586611U, which consists of a hollow junction box with attached outlet pipes, through which electric conductors are passed, enabling better accommodation and fixation of the conductors to the terminals.

Utility model CN202586607U features a way for closing the housing with a specifically shaped plate for fitting the opening of the housing. In this regard, the utility model CN2702516U proposes placing the junction box at the top of the housing. Alternatively, patent CN102790495 suggests using the junction box in a central position at the side of the housing with two plates, one on each side, which allows for cooling of the engine windings.

In light of the foregoing, the lack of feasible solutions regarding positioning with a proposal for using the junction box as partial closing of the side of the housing was evidenced.

### Objective of the Invention

This model overcomes an issue of the state of the art, featuring an ODP-type engine housing that may be closed by the bottom part of the junction box, which then accumulates the roles of housing engine terminals and closing the side opening formed by the housing production process.

### BRIEF DESCRIPTION OF THE DRAWINGS

FIG. 1 shows the ODP-type engine housing (1) with the junction box (2) fixed to the housing opening (3).

FIGS. 2 and 3 show the ODP-type engine housing (1) with the junction box (2) put in place before fixation of the housing (1). FIG. 2 further includes an example of a configuration with a shield (4) that works as a physical barrier to prevent access of small animals and insects to the inner part of the housing (1).

FIGS. 4 and 5 show an isometric view of the ODP-type housing (1), highlighting the opening (3) without the junction box (2). FIG. 4 also highlights the shield (4) that works as a physical barrier to prevent access of small animals and insects to the inner part of the housing (1).

FIG. 6 shows an example of a housing (5) that is featured in the state of the art. It is observed that the opening (6) at the housing (5) differs entirely from the concept previously provided by the featured invention.

FIGS. 7 and 8 feature the detailed fixation of the junction box.

FIG. 9 shows the ODP-type engine housing (1) with the junction box (2) placed before fixation to the housing (1) on the opposite perspective related to FIG. 2.

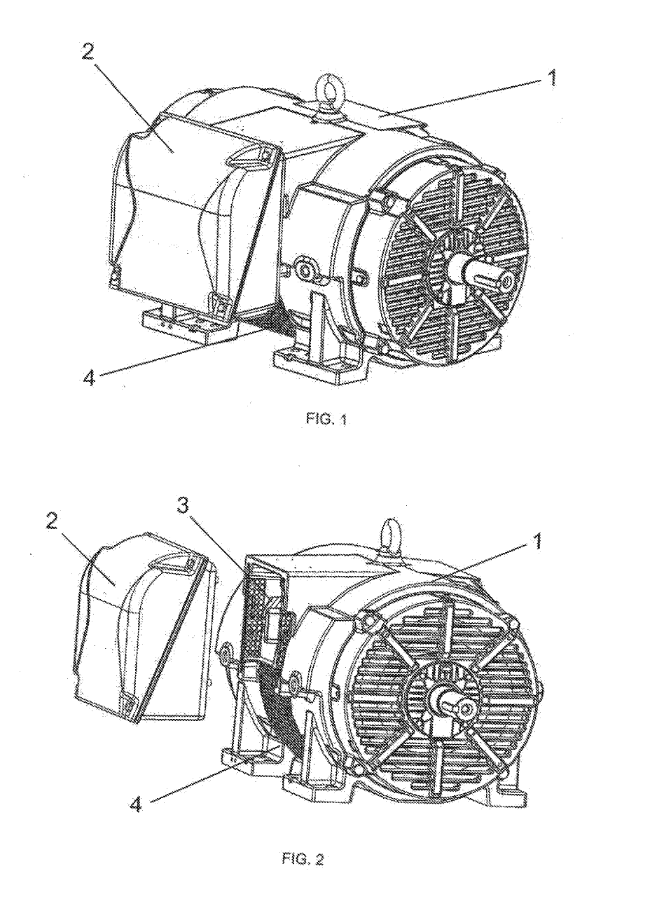

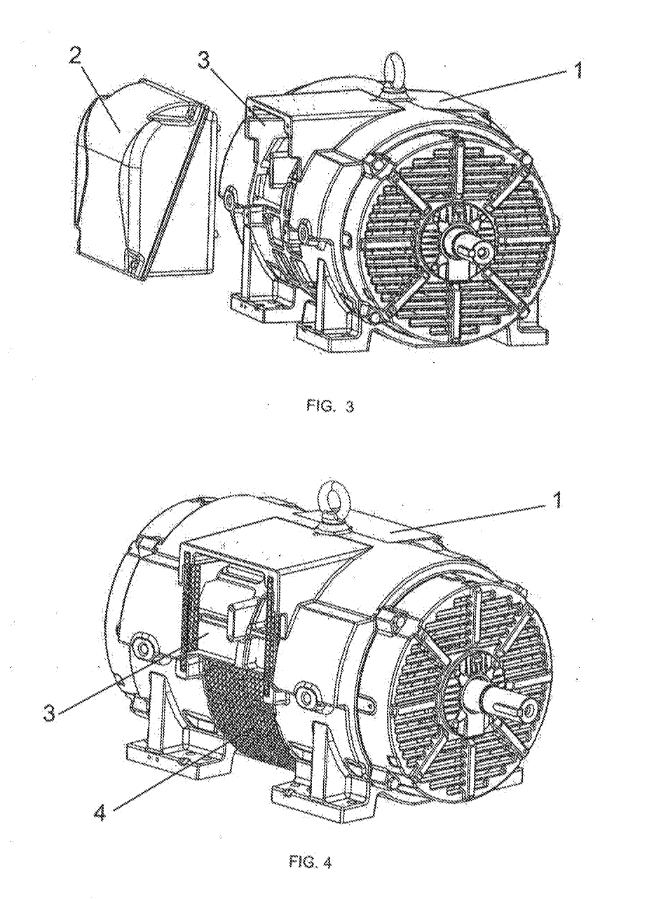

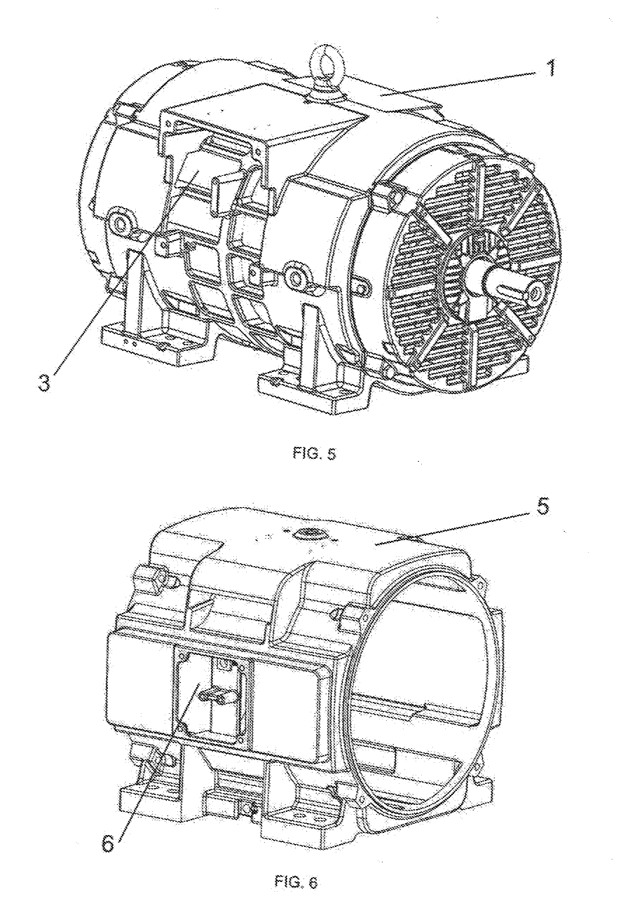

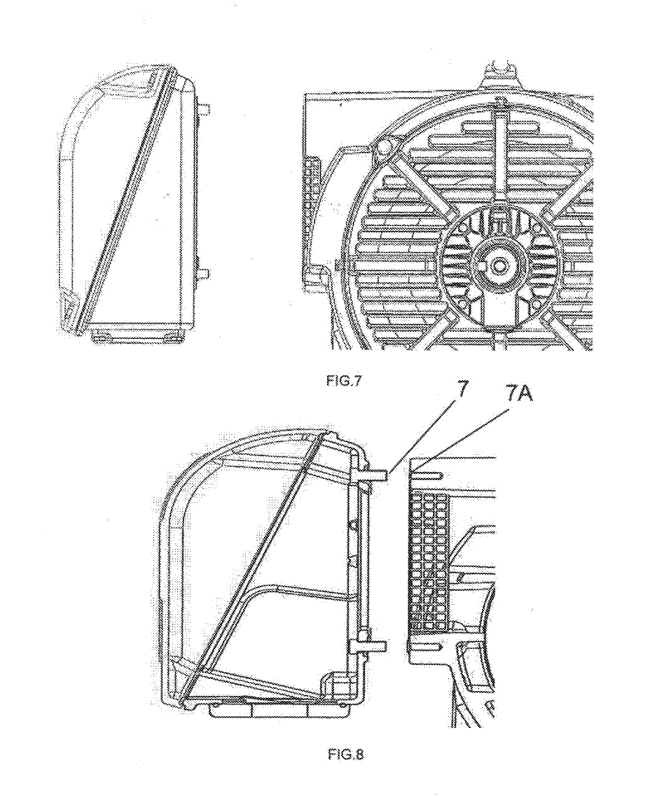

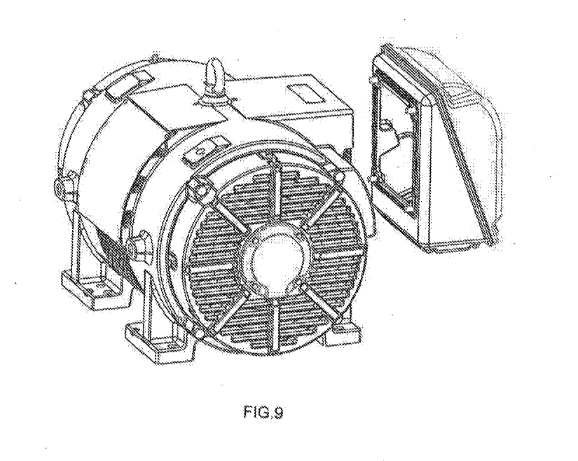

### DESCRIPTION OF THE INVENTION

This model features a housing (1) for ODP-type engines, with a closing method of the ODP-type engine housing (1) that allows the bottom part of the junction box (2), when fixed, to close the opening (3) of the housing (1).

In the construction of electric engines, housings have an opening in their structure that function as an access point to the inner chamber, enabling the connection of electric terminals of the engine winding, as well as allowing maintenance without the need to disassemble the entire engine. Although necessary, the opening (3) requires that another part is fixed to the housing in order to close said opening (3). This part requires a construction method that increases product cost.

Similarly, engine housings (1) also require a junction box (2) to house electric connections and terminals of the engine windings. This box is usually placed on the outer part of the housing, while also being fixed to said housing.

In light of the foregoing, a housing that allows the junction box to accumulate the roles of housing electric connections and closing said housing was developed, where the bottom part of said junction box is compatible with the opening of the housing. Thus, the same part simultaneously handles housing for electric connections and closing the housing.

The fixing system of the junction box is characterized for using 4 fixing elements (7), such as screws, which are attached to matching holes (7A) on the outer part of the housing.

1. (canceled)

2. An assembly comprising:
an engine housing at least partially enclosing an inner space, the engine housing having an opening therethrough for access from outside the engine housing into the inner space; and
a junction box releasably secured to the engine housing, at least a portion of the junction box covering the opening in the engine housing.

3. The assembly of claim 2, wherein the junction box comprises a fixing element extending from the junction box for cooperative engagement with a fixing element retention mechanism in the engine housing for releasably securing the junction box to the engine housing.

4. The assembly of claim 2 further comprising a shield for the opening positioned between the junction box and the engine housing.

5. An arrangement inserted into ODP-type electric engine housing with part of the electric engine housing closed by a junction box, wherein the electric engine housing features a rectangular opening resulting from the casting process without use of casting plugs, which enables access to an inner part of the electric engine housing, the opening being at least partially closed by a bottom part of the junction box, the bottom part of the junction box being compatible with the opening of the electric engine housing so that the junction box simultaneously performs both roles of housing electric connections and closing the opening of the electric engine housing when attached to the electric engine housing by a releasable fixing system that operates through fixing elements that match holes in the electric engine housing, the electric engine housing further comprising a shield that limits access to the inner part of the electric engine housing.

6. The arrangement of claim 5, wherein the fixing elements comprise screws.
